(19) United States
(12) Patent Application Publication
(10) Pub. No.: US 2026/0342481 A1
(43) Pub. Date: Oct. 29, 2026

(54) DIFFERENTIAL SPACE-TIME LINE CODED SYSTEM AND METHOD

(71) Applicant: CHUNG ANG UNIVERSITY INDUSTRY ACADEMIC COOPERATION FOUNDATION, Seoul (KR)

(72) Inventor: Jin Gon JOUNG, Seoul (KR)

(21) Appl. No.: 19/705,256

(22) Filed: Jun. 11, 2026

Related U.S. Application Data
(63) Continuation of application No. PCT/KR2024/095866, filed on May 30, 2024.

(30) Foreign Application Priority Data
Jan. 10, 2024 (KR) 10-2024-0004189

(51) Int. Cl. H04L 1/06

(52) U.S. Cl. CPC H04L 1/0625

(57) ABSTRACT

Differential space-time line coded system and method without using channel information are disclosed. A transmitter employed in the differential space-time line coded system includes a space-time encoding unit configured to space-time encode input symbols and at least one transmitting antenna. Here, the space-time encoding unit space-time encodes the input symbols without using channel information, and the encoded input symbols are transmitted to a receiver through the transmitting antenna.

### CROSS-REFERENCE TO RELATED APPLICATIONS

This application is a Bypass continuation of pending PCT International Application No. PCT/KR2024/095866, which was filed on May 30, 2024, and which claims priorities under 35 U.S.C 119(a) to Korean Patent Application No. 10-2024-0004189 filed with the Korean Intellectual Property Office on Jan. 10, 2024. The disclosures of the above patent applications are incorporated herein by reference in their entirety.

### TECHNICAL FIELD

The present disclosure relates to differential space-time line coded system and method.

### BACKGROUND ART

A well-known space-time block code STBC of a space-time code technique STC using multiple transmitting/receiving antennas transmits a block-type code without using channel information, and maximum spatial diversity gain is obtained by using channel information estimated by a receiver. The STBC technique was initially applied to time-invariant channel environments and was not suitable for time-varying channel environments.

Recently developed space-time line coded STLC technique is a technique that forms perfect symmetry with conventional STBC, in which channel information is used at the transmitter rather than at the receiver, and the receiver provides the same performance as the STBC through simple linear combination of received signals without channel information.

The STLC technique was also initially implemented in a time-invariant channel environment. The conventional STLC technique, like the early STBC technique, was developed on the assumption of the time-invariant channel environment, and thus it was difficult to acquire rapidly varying channel information in a time-varying channel environment, particularly when a moving speed was high.

Accordingly, it is necessary to develop the STLC technique suitable for the time-varying channel environment.

### STATEMENT REGARDING PRIOR DISCLOSURES BY THE INVENTOR OR A JOINT INVENTOR

At least one inventor or joint inventor of the present disclosure has made related disclosures in a research paper—the SSRN platform (“Differential Space-Time Line Codes” by JOUNG, Jingon et al.) on Dec. 1, 2023, which was included in the information disclosure statement submitted with this application.

### SUMMARY

The present disclosure is to provide differential time-space line coded system and method.

A transmitter employed in a differential space-time line coded system according to an embodiment of the present disclosure includes a space-time encoding unit configured to space-time encode input symbols; and at least one transmitting antenna. Here, the space-time encoding unit space-time encodes the input symbols without using channel information, and the encoded input symbols are transmitted to a receiver through the transmitting antenna.

A transmitter employed in a space-time line coded system according to another embodiment of the present disclosure includes a space-time encoding unit configured to space-time encode an input symbol; and at least one transmitting antenna. Here, wherein the space-time encoding unit generates a reference STLC signal by space-time encoding a reference symbol as the input symbol, normalizes the generated reference STLC signal using a weight, and transmits the normalized reference STLC signal to a receiver through the transmitting antenna.

A receiver employed in a space-time line coded system according to an embodiment of the present disclosure includes two or more receiving antennas; and a space-time decoding unit configured to receive space-time encoded STLC symbols from a transmitter with one transmitting antenna through the receiving antennas, form a receiving signal matrix using the received space-time encoded STLC symbols, and decode the receiving signal matrix. Here, the receiving signal matrix is determined by previous receiving signal matrix and an input symbol inputted to the transmitter.

Differential space-time line coded system and method of the present disclosure may space-time encode an input symbol without using channel information at a transmitter and thus the encoding is simple. Additionally, a receiver may perform simply a decoding process without using the channel information, and thus the decoding process is simple and the differential space-time line coded system may provide very excellent communication performance even in environments with severe channel variations. Accordingly, the differential space-time line coded system may be suitably used for various mobile communications with time-varying channel environment.

### BRIEF DESCRIPTION OF DRAWINGS

Example embodiments of the present disclosure will become more apparent by describing in detail example embodiments of the present disclosure with reference to the accompanying drawings, in which:

FIG. 1 is a view illustrating concept of a differential space-time line coded system according to an embodiment of the present disclosure;

FIG. 2 is a view illustrating a structure of a transmitter according to an embodiment of the present disclosure;

FIG. 3 is a view illustrating a space-time encoding process according to an embodiment of the present disclosure;

FIG. 4 is a view illustrating a structure of a receiver according to an embodiment of the present disclosure;

FIG. 5 is a view illustrating a space-time decoding process according to an embodiment of the present disclosure;

FIG. 6 is a view illustrating constellation diagram;

FIG. 7 is a view illustrating comparison result of BER performance according to signal to noise;

FIG. 8 is a view illustrating BER performance according to channel variation (f_{d}Tₛ);

FIG. 9 is a view illustrating a transmitter in a differential space-time line coded system according to another embodiment of the present disclosure; and

FIG. 10 is a view illustrating a receiver in the differential space-time line coded system according to another embodiment of the present disclosure.

### DETAILED DESCRIPTION

In the present specification, an expression used in the singular encompasses the expression of the plural, unless it has a clearly different meaning in the context. In the present specification, terms such as “comprising” or “including,” etc., should not be interpreted as meaning that all of the elements or operations are necessarily included. That is, some of the elements or operations may not be included, while other additional elements or operations may be further included. Also, terms such as “unit,” “module,” etc., as used in the present specification may refer to a part for processing at least one function or action and may be implemented as hardware, software, or a combination of hardware and software.

The present disclosure relates to differential space-time line coded system and method, and may be suitably used for a mobile communication, such as vehicle communication, train communication, airport communication or satellite communication, etc., with a time-varying channel environment.

In an embodiment, the differential space-time line coded system may space-time encode a symbol without using channel information and then transmits the encoded symbol through one transmitting antenna at a transmitter, and space-time decode symbols received through two receiving antennas at a receiver. The differential space-time line coded system may have very simple structure with providing very excellent communication performance even in severe channel variant environment. Accordingly, the differential space-time line coded system may be suitably used for various mobile communications with the time-varying environment.

Hereinafter, various embodiments of the present disclosure will be described in detail with reference to accompanying drawings.

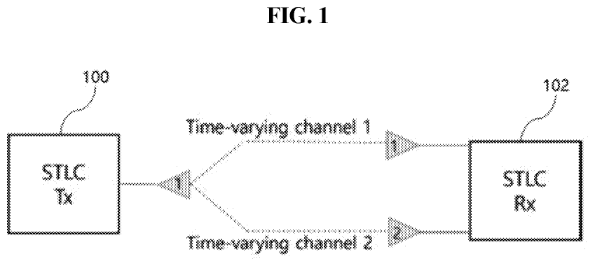

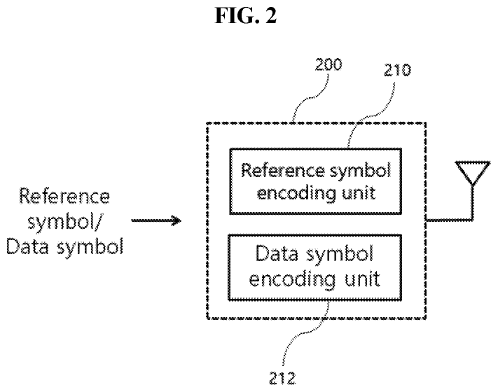

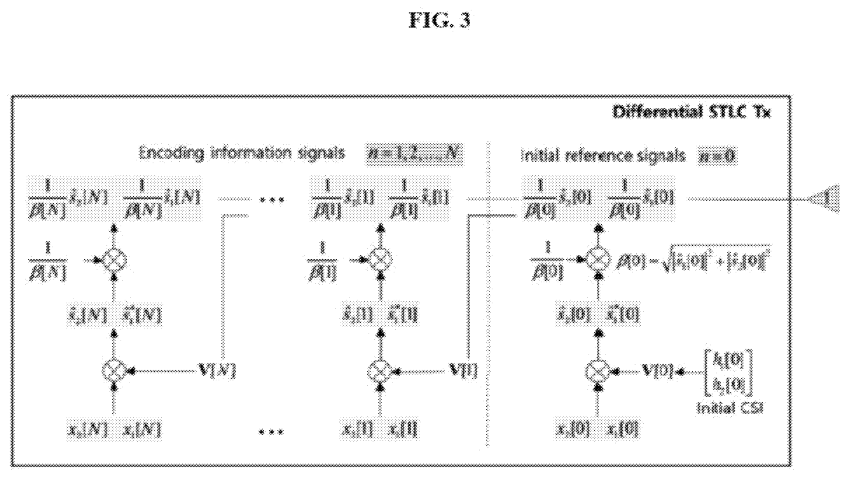

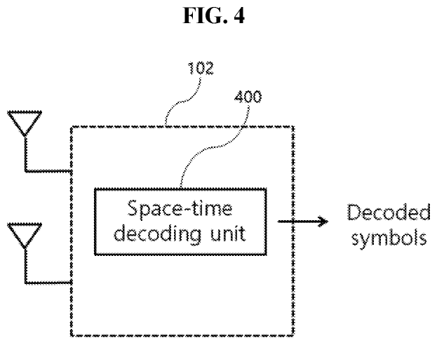

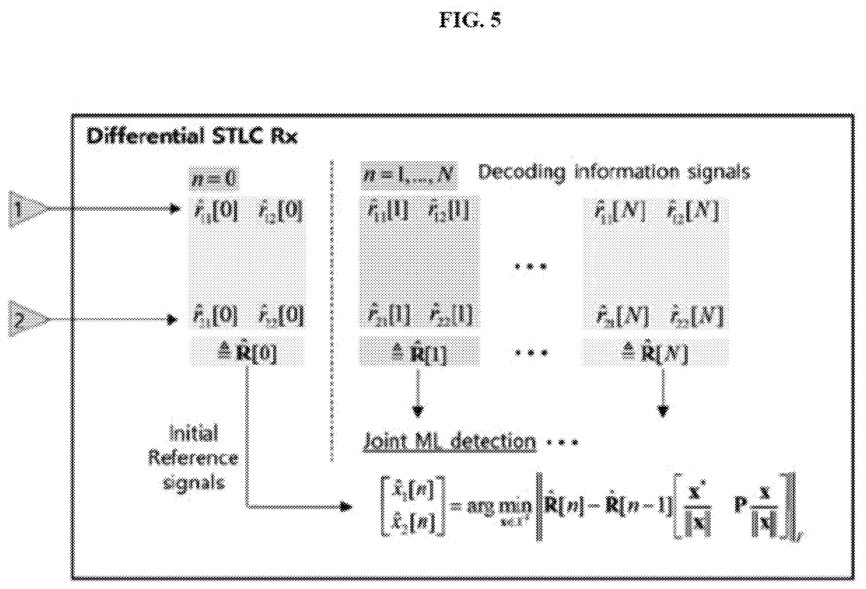

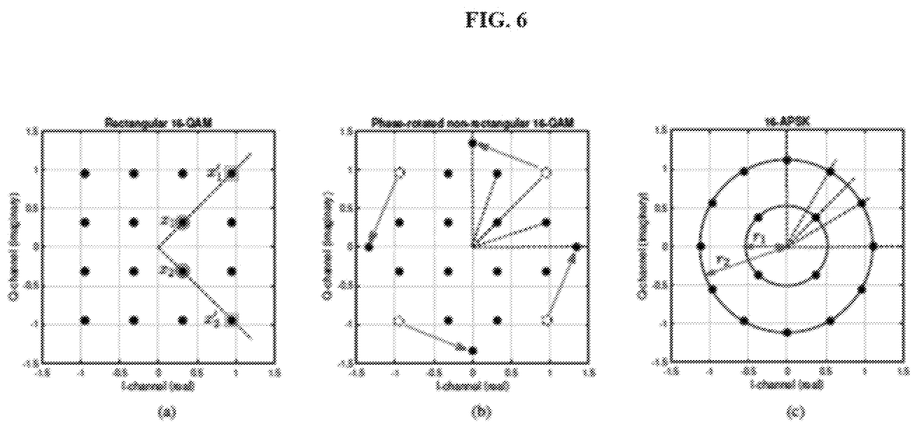

FIG. 1 is a view illustrating concept of a differential space-time line coded system according to an embodiment of the present disclosure, FIG. 2 is a view illustrating a structure of a transmitter according to an embodiment of the present disclosure, FIG. 3 is a view illustrating a space-time encoding process according to an embodiment of the present disclosure, FIG. 4 is a view illustrating a structure of a receiver according to an embodiment of the present disclosure, FIG. 5 is a view illustrating a space-time decoding process according to an embodiment of the present disclosure, and FIG. 6 is a view illustrating constellation diagram.

In FIG. 1, a differential space-time line coded system of the present embodiment may include a transmitter 100 and a receiver 102 communicating in a time-varying channel environment.

In an embodiment, the transmitter 100 may use one transmitting antenna, and the receiver 102 may employ two receiving antennas. Specially, the transmitter 100 may space-time encode a symbol without using channel information.

Hereinafter, a structure and operation of the receiver 102 will be described after a structure and operation of the transmitter 100 will be described.

### The Structure and the Operation of the Transmitter 100

In FIG. 2, the transmitter 100 includes a space-time encoding unit 200 and one transmitting antenna. The space-time encoding unit 200 may include a reference symbol encoding unit 210 for space-time encoding a reference symbol and a data symbol encoding unit 212 for encoding a data symbol inputted after the reference symbol.

In an embodiment, the space-time encoding unit 200 may transmit encoded reference symbol after space-time encoding a reference symbol as an input symbol without using channel information, and then transmit encoded data symbol after space-time encoding a data symbol without using the channel information. That is, unlike conventional space-time line coded technique using full channel information at a transmitter, the differential space-time line coded system of the present disclosure does not use the channel information. Nevertheless, the differential space-time line coded system of the present disclosure may provide more excellent communication performance than the conventional space-time line coded system in a time-varying channel environment. That is because the differential space-time line coded system normalizes differential STLC symbols (STLC signals) space-time encoded independently without using the channel information and then transmits the normalized differential STLC symbols to the receiver 102.

### Transmission of Reference Symbol

The reference symbol encoding unit 210 may generate reference differential STLC signals (0^{th} differential STLC symbols, n=0) by space-time encoding symbols (x1[0], x2[0]) as shown in following equation 1, when the two symbols (x1[0], x2[0]) as the reference symbol are inputted. Here, n means an STLC index.

$$\begin{matrix}[ \begin{matrix}{\hat{s}}_{1}^{*} [ 0 ] \\ {\hat{s}}_{2} [ 0 ]\end{matrix} ] = [ \begin{matrix}{v}_{1} [ 0 ] & {v}_{2} [ 0 ] \\ {v}_{2}^{*} [ 0 ] & - {v}_{1}^{*} [ 0 ]\end{matrix} ] [ \begin{matrix}{x}_{1} [ 0 ] \\ {x}_{2} [ 0 ]\end{matrix} ] \\ = V [ 0 ] x [ 0 ] .\end{matrix} \qquad [ Equation 1 ]$$

Here, a symbol (xᵢ[0]) means an arbitrary reference symbol (reference signal) not 0 and is not decoded at the receiver 102, and vᵢ[0] indicates initial differential STLC encoding matrix and may be a random value.

Subsequently, the reference symbol encoding unit 210 may power-normalize the reference differential STLC signal to limit power when the reference differential STLC signal is transmitted as shown in following equation 2.

$$\frac{1}{β [ 0 ]} {s}_{k} [ 0 ] \text{?} k ∈ \{ 1 \text{?} 2 \} \qquad [ Equation 2 ]$$

$$\text{?} \text{indicates text missing or illegible when filed}$$

Here, β means a weight, and β[0] may be obtained based on the reference signal as shown in following equation 3.

$$β [ 0 ] = \sqrt{\frac{{\vert {\hat{s}}_{1} [ 0 ] \vert}^{2} + {\vert {\hat{s}}_{2} [ 0 ] \vert}^{2}}{2}} \qquad [ Equation 3 ]$$

Then, the reference symbol encoding unit 210 may transmit the normalized reference differential STLC signals to the receiver 102 through the transmitting antenna. Preferably, the reference symbol encoding unit 210 may transmit sequentially s1[0]/P[0] and s2[0]/β[0] to the receiver 102.

Briefly, the reference symbol encoding unit 210 normalizes the differential STLC signal with a weight based on the reference signal and transmits the normalized differential STLC signal to the receiver 102. This entire process is shown in a right image in FIG. 3.

### Transmission of Data Symbol

If the data symbol to be transmitted as an input symbol is defined in following equation 4, the data symbol encoding unit 212 may generate nth differential STLC signal as shown in following equation 5.

x^{T}=[x₁[1]x₂[1] . . . x₁[n]x₂[n] . . . x₁[N]x₂[N]],n=1, . . . ,N, [Equation 4]

$$[ \begin{matrix}{\hat{s}}_{1}^{*} [ n ] \\ {\hat{s}}_{2} [ n ]\end{matrix} ] = V [ n ] x [ n ] \text{?} n = 1 \text{?} … , N . \qquad [ Equation 5 ]$$

$$\text{?} \text{indicates text missing or illegible when filed}$$

Here, V[n] may be implemented with previously encoded differential STLC symbols as shown in following equation 6.

$$V [ n ] = \frac{1}{β [ n - 1 ]} [ \begin{matrix}{\hat{s}}_{1}^{*} [ n - 1 ] & {\hat{s}}_{2}^{*} [ n - 1 ] \\ {\hat{s}}_{2} [ n - 1 ] & - {\hat{s}}_{1} [ n - 1 ]\end{matrix} ] \qquad [ Equation 6 ]$$

In equation 6, a first differential STLC encoding matrix (V[1]) may be obtained from the normalized reference differential STLC signal. As a result, the first differential STLC encoding matrix (V[1]) reflects information concerning the reference signal, and thus nth STLC encoding matrix (V[n]) reflects also the information concerning the reference signal. That is, the space-time encoding unit 200 does not use the channel information.

Subsequently, the data symbol encoding unit 212 may power-normalize a differential STLC signal. Here, a weight β used when n is 1 may be defined as in shown in following equation 7. Accordingly, nth weight β is derived as shown in following equation 8.

$$\begin{matrix}\text{?} = \text{?} \\ = \text{?} \\ \text{?} \text{?} \\ = \text{?} \\ = 2\end{matrix} \qquad [ Equation 7 ]$$

$$β [ \text{?} ] = \sqrt{{\vert \text{?} \vert}^{2} + {\vert \text{?} \vert}^{2}} \text{?}$$

$$β [ n ] = \sqrt{{\vert {x}_{1} [ n ] \vert}^{2} + {\vert {x}_{2} [ n ] \vert}^{2}} = ‖ x [ n ] ‖ \text{?} \qquad [ Equation 8 ]$$

$$\text{?} \text{indicates text missing or illegible when filed}$$

In equation 8, it is verified that the weight for the normalization does not depend on the channel information and may be determined by the input symbol xₖ[n]. If non-constant modulus constellation is used, nth weight β[n] may be determined by two input symbols (x1[n] and x2[n]).

Then, the data symbol encoding unit 212 may transmit the normalized differential STLC signals to the receiver 102 through the transmitting antenna. Preferably, the data symbol encoding unit 212 may transmit sequentially s1[n]/β[n] and s2[n]/β[n] to the receiver 102.

Shortly, the data symbol encoding unit 212 determines the weight for the reference differential STLC signal by the input symbols, unlike conventional technique where a weight is determined by the channel information. As a result, the data symbol encoding unit 212 does not also use the channel information. A detailed process is shown in FIG. 3.

Briefly, in the transmitter, the space-time encoding unit 200 may space-time encode the reference symbol without using the channel information, normalize the encoded reference symbol, transmit the normalized encoded reference symbol to the receiver 102, space-time encode the data symbol inputted after the reference symbol using the reference symbol or previously encoded data symbol, normalize the encoded data symbol and transmit the normalized encoded data symbol to the receiver 102. Since the transmitter 100 does not use the channel information, the decoding process is simple. Furthermore, normalized differential STLC signal is transmitted to the receiver 102, thereby suppressing noise and realizing excellent communication performance, e.g. bit error rate (BER) by limiting variation in the time-variant channel environment.

### The Structure and the Operation of the Receiver 102

In FIG. 4, the receiver 102 includes two receiving antennas and a space-time decoding unit 400.

If two receiving signals (differential STLC signals) first received through a first receiving antenna and a second receiving antenna are respectively defined as r11[n] and r21[n] and two receiving signals (differential STLC signals) next received through the receiving antennas are respectively defined as r12[n] and r22[n], an nth receiving signal matrix is shown in following equation 9. The transmitter 100 transmits sequentially two differential STLC symbols and the receiver 102 receives two STLC symbols through two receiving antennas, and thus the receiving signal matrix may be expressed as following equation 9.

$$\begin{matrix}\text{?} \hat{=} [ \begin{matrix}\text{?} & \text{?} \\ \text{?} & \text{?}\end{matrix} ] \\ = [ \begin{matrix}h \text{?} & h \text{?}\end{matrix} ] + Z \text{?} \\ ≃ h \text{?} + Z \text{?}\end{matrix} \qquad [ Equation 9 ]$$

$$\text{?} \text{indicates text missing or illegible when filed}$$

Here, Z[n] means effective noise, and it is assumed that present channel state is similar to previous channel state, i.e. h[2n]≈h[2n−1].

On the other hand, nth transmitted differential STLC signals (s1[n] and s2[n]) may be expressed as following equation 10 when equation 5 and equation 6 are used.

$$\begin{matrix}\text{?} = \frac{1}{β [ n - 1 ]} [ \begin{matrix}\text{?} [ n - 1 ] & \text{?} [ n - 1 ] ] [ \begin{matrix}{x}_{1}^{*} [ n ] \\ {x}_{2}^{*} [ n ]\end{matrix} ]\end{matrix} \\ \text{?} = \frac{1}{β [ n - 1 ]} [ \begin{matrix}\text{?} [ n - 1 ] & - \text{?} [ n - 1 ] ] [ \begin{matrix}{x}_{1} [ n ] \\ {x}_{2} [ n ]\end{matrix} ]\end{matrix} \\ = \frac{1}{β [ n - 1 ]} [ \begin{matrix}\text{?} [ n - 1 ] & \text{?} [ n - 1 ] ] [ \begin{matrix}{x}_{1} [ n ] \\ - {x}_{2} [ n ]\end{matrix} ]\end{matrix} \\ = \frac{1}{β [ n - 1 ]} [ \begin{matrix}\text{?} [ n - 1 ] & \text{?} [ n - 1 ] ] [ \begin{matrix}- {x}_{2} [ n ] \\ {x}_{1} [ n ]\end{matrix} ]\end{matrix}\end{matrix} \qquad [ Equation 10 ]$$

$$\text{?} \text{indicates text missing or illegible when filed}$$

The receiving signal matrix may be simplified as following equation 11 when equation 10 is substituted into equation 9.

$$\begin{matrix}\text{?} = \frac{1}{β [ n ]} h [ 2 n - 1 ] \frac{1}{β [ n - 1 ]} \text{?} \\ \times [ \begin{matrix}{x}_{1}^{*} [ n ] & - {x}_{2} [ n ] \\ {x}_{2}^{*} [ n ] & {x}_{1} [ n ]\end{matrix} ] + Z [ n ] \\ = \frac{1}{β [ n ]} \{ h [ 2 n - 1 ] \frac{1}{β [ n - 1 ]} \text{?} \} \\ \times [ \begin{matrix}{x}^{*} [ n ] & P \text{?} [ n ] ] + Z [ n ] \text{?}\end{matrix} \\ \text{?} \frac{1}{β [ n ]} \{ h [ 2 ( n - 1 ) - 1 ] \frac{[ \begin{matrix}\text{?} & \text{?} ]\end{matrix}}{β [ n - 1 ]} \} \\ \times [ \begin{matrix}{x}^{*} [ n ] & P \text{?} [ n ] ] + Z [ n ]\end{matrix}\end{matrix} \qquad [ Equation 11 ]$$

$$\text{?} \text{indicates text missing or illegible when filed}$$

Here,

$$P = [ \begin{matrix}0 & - 1 \\ 1 & 0\end{matrix} ] ,$$

and it is assumed that h[2n−1]≈h[2n−3] if channels are highly correlated within 4 Ts.

In this case, the receiving signal matrix is expressed as following equation 12 when equation 9 and equation 10 are compared, and an effective noise matrix may be expressed as following equation 13.

$$\begin{matrix}\text{?} [ n ] = \text{?} ( \text{?} ) [ \text{?} ] + Z \text{?} \\ = \text{?} ( \text{?} ) [ \text{?} ] + Z \text{?} \\ = \text{?} [ \text{?} ] + \text{?}\end{matrix} \qquad [ Equation 12 ]$$

$$\hat{Z} [ n ] \hat{=} Z [ n ] - Z [ n - 1 ] [ \begin{matrix}\frac{\text{?} [ n ]}{‖ x [ n ] ‖} & P \frac{x [ n ]}{‖ x [ n ] ‖}\end{matrix} ] \qquad [ Equation 13 ]$$

$$\text{?} \text{indicates text missing or illegible when filed}$$

Referring to equation 12 and equation 13, present receiving signal matrix may be determined by previous receiving signal matrix and the input symbols of the transmitter 100.

Subsequently, if the effective noise (Z[n]) is additive white Gaussian noise (AWGN), it is possible to decode the received symbols by using a joint maximum likelihood scheme. That is, the space-time decoding unit 400 may decode the symbols using the joint maximum likelihood scheme as shown in following equation 14.

$$[ Equation 14 ]$$

$$[ \begin{matrix}{\hat{x}}_{1} [ n ] \\ {\hat{x}}_{2} [ n ]\end{matrix} ] = \text{?} [ n ] = arg \text{?} ‖ \text{?} [ n ] - \text{?} [ n - 1 ] [ \begin{matrix}\text{?} & \text{?}\end{matrix} ] \text{?}$$

$$\text{?} \text{indicates text missing or illegible when filed}$$

Entire space-time decoding process is shown in FIG. 5. In FIG. 5, it is verified that the received differential STLC signals are decoded without the channel information. That is, the receiver 102 may decode normally the symbols though the transmitter 100 encodes the input symbols without using the channel information.

Briefly, the receiver 102 in the differential space-time line coded system of the present disclosure does not use the channel information. However, decoding complexity of the differential space-time line coded system of the present disclosure may increase slightly according as the joint maximum likelihood scheme is employed, but the differential space-time line coded system may have excellent communication performance.

In terms of modulation having a non-constant modulus constellation, ambiguity exists when the maximum likelihood scheme of equation 14 is used. For example, as illustrated in (a) of FIG. 6, when two symbol vectors in a rectangular 16-QAM constellation are normalized, their magnitudes become identical, and thus they are distinguished only by their phases. As a result, x and x′ generate the same cost and are therefore ambiguous. In order to avoid such ambiguity, a non-rectangular 16-point modulation may be designed such that four corner symbols among the 16-QAM constellation points have phase rotation (PR), as illustrated in (b) of FIG. 6. In addition, as another method of avoiding such ambiguity, 16-APSK as illustrated in (c) of FIG. 6 may be used. The inner ring has four states, and the outer ring has twelve states. Magnitude ratio of the inner ring and the outer ring equals to

$$\frac{\sqrt{2}}{3} ,$$

and phase angle of the inner ring and phase angle of the outer ring are π/2 and π/6, respectively. Phases of symbols differ one another as shown in (b) and (c) of FIG. 6, and so ambiguity does not exist when the maximum likelihood scheme is applied.

\hat{R}[n−1] is a 2-by-2 matrix channel in the maximum likelihood scheme in equation 14 but is a 2-by-1 vector channel in conventional STBC technique. As a result, the differential space-time line coded system of the present disclosure has excellent encoding gain than conventional techniques, and so performance may be enhanced in view of noise in equation 13.

One transmitting antenna and two receiving antennas are used in above description, but two or more transmitting antennas and at least three receiving antennas may be used. That is, it is sufficient that one or more transmitting antenna and at least two receiving antennas are used. For example, the use of a 1×2 antenna configuration may be extended such that a 2×4 antenna configuration may be used.

Hereinafter, experimental results of the differential space-time line coded system of the present disclosure and conventional techniques will be described.

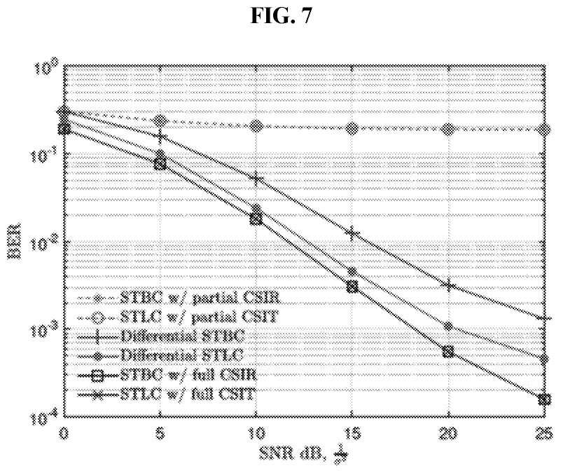

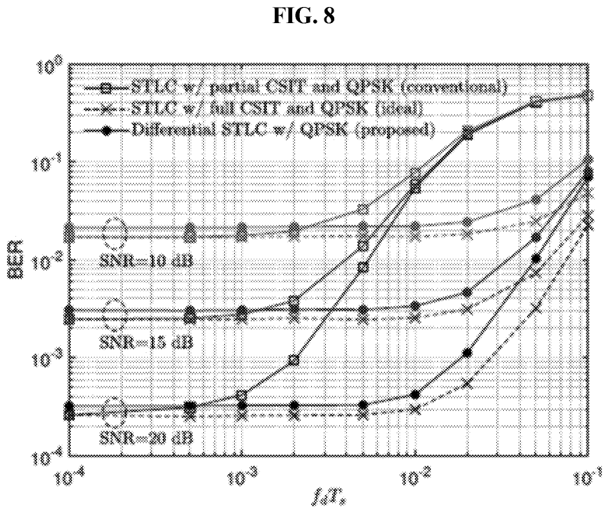

FIG. 7 is a view illustrating comparison result of BER performance according to signal to noise, and FIG. 8 is a view illustrating BER performance according to channel variation (f_{d}Tₛ). Compared techniques as follows.
1. STBC w/partial CSIR: conventional STBC system using only initial channel information (partial CSIR) at a receiver/2. STLC w/partial CSIT: an STLC system using initial channel information (partial CSIT) at a transmitter/3. Differential STBC: conventional differential STBC system using only initial channel information (partial CSIR) at a receiver/4. Differential STLC: provided differential STLC system (present disclosure) not using channel information at a transmitter/5. STBC w/full CSIR: conventional STBC system using ideally every channel information at a receiver/6. STLC w/full CSIT: conventional STLC system using ideally every channel information at a transmitter

In FIG. 7, it can be confirmed that BER performance of the present disclosure is closest to the BER performance obtained when rapidly varying channel information is ideally known (STBC w/full CSIR and STLC w/full CSIT). In the case of the STBC system and the STLC system as other conventional techniques, the BER performance degradation is very severe. That is, it is verified that the differential space-time line coded system of the present disclosure has excellent BER performance even without using channel information.

In FIG. 8, in conventional STLC system, the BER performance degrades very sensitively as the channel variation (f_{d}Tₛ) increases. In contrast, it is verified that the differential space-time line coded system of the present disclosure is highly robust against an increase in channel variation, similarly to performance of the ideal system. In conventional STLC system, the BER performance is maintained only up to a channel variation of about 0.0007, whereas the differential space-time line coded system of the present disclosure maintains the BER performance up to a channel variation of about 0.01.

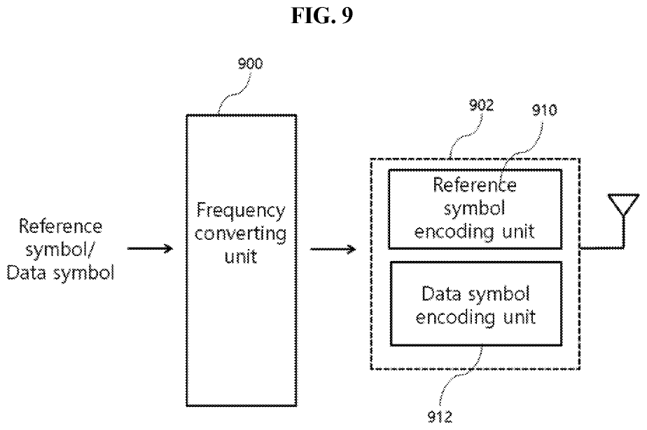

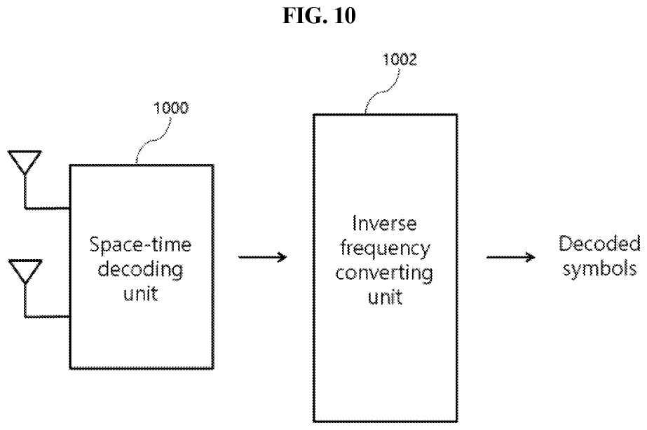

FIG. 9 is a view illustrating a transmitter in a differential space-time line coded system according to another embodiment of the present disclosure, and FIG. 10 is a view illustrating a receiver in the differential space-time line coded system according to another embodiment of the present disclosure.

In FIG. 9, a transmitter 100 of the present embodiment includes a frequency converting unit 900, a space-time encoding unit 902 and one transmitting antenna. Here, the space-time encoding unit 902 includes a reference symbol encoding unit 910 and a data symbol encoding unit 912.

The transmitter 100 of the present embodiment further includes the frequency converting unit 900 compared to the transmitter 100 in FIG. 2.

The frequency converting unit 900 converts a reference symbol/a data symbol into a symbol in frequency domain by applying Fourier transform to the reference symbol/the data symbol, and the space-time encoding unit 902 space-time encodes the symbol in the frequency domain. The operation of the space-time encoding unit 902 is identical to that in FIG. 2 except for being in the frequency domain. Accordingly, further description concerning the encoding process will be omitted.

In FIG. 10, a receiver 102 of the present embodiment includes two receiving antennas, a space-time decoding unit 1000 and an inverse frequency converting unit 1002.

The receiver 102 of the present embodiment further includes the inverse frequency converting unit 1002 compared to the receiver 102 in FIG. 4.

The space-time decoding unit 1000 decodes the same process as in above embodiment except for being in the frequency domain, and the inverse frequency converting unit 1002 converts the symbol in the frequency domain into a symbol in time domain. The decoding process is the same, and thus further description concerning the decoding process will be omitted.

Components in the embodiments described above can be easily understood from the perspective of processes. That is, each component can also be understood as an individual process. Likewise, processes in the embodiments described above can be easily understood from the perspective of components.

Also, the technical features described above can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc. Examples of the program of instructions may include not only machine language codes produced by a compiler but also high-level language codes that can be executed by a computer through the use of an interpreter, etc. The hardware mentioned above can be made to operate as one or more software modules that perform the actions of the embodiments of the invention, and vice versa.

The embodiments of the invention described above are disclosed only for illustrative purposes. A person having ordinary skill in the art would be able to make various modifications, alterations, and additions without departing from the spirit and scope of the invention, but it is to be appreciated that such modifications, alterations, and additions are encompassed by the scope of claims set forth below.

What is claimed is:

1. A transmitter employed in a differential space-time line coded system comprising:
a space-time encoding unit configured to space-time encode input symbols; and
at least one transmitting antenna,
wherein the space-time encoding unit space-time encodes the input symbols without using channel information, and the encoded input symbols are transmitted to a receiver through the transmitting antenna.

2. The transmitter of claim 1, wherein the space-time encoding unit includes:
a reference symbol encoding unit configured to space-time encode a reference symbol as an input symbol without using the channel information; and
a data symbol encoding unit configured to space-time encode a data symbol as the input symbol using information concerning the encoded reference symbol.

3. The transmitter of claim 2, wherein the reference symbol encoding unit generates a reference differential STLC signal by space-time encoding the reference symbol without using the channel information, and normalizes the generated reference differential STLC signal using a weight,
and wherein the normalized reference differential STLC signal is transmitted to the receiver through the transmitting antenna.

4. The transmitter of claim 3, wherein the weight is obtained based on the reference symbol without using the channel information,
and wherein the receiver includes two or more receiving antennas.

5. The transmitter of claim 2, wherein the data symbol encoding unit generates a first differential STLC signal by multiplying the encoded reference symbol and a first data symbol, and normalizes the generated first differential STLC signal using a first weight,
and wherein the normalized first differential STLC signal is transmitted to the receiver through the transmitting antenna, and the first weight is determined by the first data symbol without using the channel information.

6. The transmitter of claim 5, wherein the data symbol encoding unit generates a second differential STLC signal by multiplying the first differential STLC signal and a second data symbol inputted after the first data symbol, and normalizes the generated second differential STLC signal using a second weight,
and wherein the normalized second differential STLC signal is transmitted to the receiver through the transmitting antenna, and the second weight is determined by the second data symbol without using the channel information.

7. The transmitter of claim 1, further comprising:
a frequency converting unit generates an input symbol in frequency domain by performing frequency transform to the input symbol,
wherein the space-time encoding unit space-time encodes the input symbol in the frequency domain.

8. A transmitter employed in a space-time line coded system comprising:
a space-time encoding unit configured to space-time encode an input symbol; and
at least one transmitting antenna,
wherein the space-time encoding unit generates a reference STLC signal by space-time encoding a reference symbol as the input symbol, normalizes the generated reference STLC signal using a weight, and transmits the normalized reference STLC signal to a receiver through the transmitting antenna.

9. The transmitter of claim 8, wherein the weight is obtained based on the reference symbol without using channel information,
and wherein the receiver includes two or more receiving antennas.

10. A receiver employed in a space-time line coded system comprising:
two or more receiving antennas; and
a space-time decoding unit configured to receive space-time encoded STLC symbols from a transmitter with one transmitting antenna through the receiving antennas, form a receiving signal matrix using the received space-time encoded STLC symbols, and decode the receiving signal matrix,
wherein the receiving signal matrix is determined by previous receiving signal matrix and an input symbol inputted to the transmitter.

11. The receiver of claim 10, wherein the space-time encoded STLC symbols is generated by encoding the input symbol without using channel information at the transmitter.

12. The receiver of claim 10, wherein the space-time encoded STLC symbols are generated by normalizing encoded input symbol using a weight after encoding by applying previous space-time encoded STLC symbol to present input symbol at the transmitter, and
wherein the weight is determined by the input symbol.

13. The receiver of claim 12, wherein the previous space-time encoded STLC symbol is space-time encoded without using channel information.

14. The receiver of claim 10, wherein the space-time decoding unit decodes the receiving signal matrix using joint maximum likelihood scheme.

15. The receiver of claim 14, further comprising:
an inverse frequency converting unit configured to convert the decoded receiving signal matrix in frequency domain into a signal in time domain by applying inverse-frequency transform to the decoded receiving signal matrix.
